(19) United States
(12) Patent Application Publication
(10) Pub. No.: US 2023/0234347 A1
(43) Pub. Date: Jul. 27, 2023

(54) RECYCLABLE RESEALABLE LAMINATE STRUCTURE

(71) Applicant: Sonoco Development, Inc., Hartsville, SC (US)

(72) Inventors: Scott William Huffer, Hartsville, SC (US); Donald Taylor, Hartsville, SC (US)

(21) Appl. No.: 18/096,269

(22) Filed: Jan. 12, 2023

Related U.S. Application Data
(60) Provisional application No. 63/299,224, filed on Jan. 13, 2022.

(51) Int. Cl. B32B 27/32; B32B 27/30; B32B 27/08; B32B 27/20; B32B 7/12; B32B 7/02

(52) U.S. Cl. CPC B32B 27/32; B32B 7/02; B32B 7/12; B32B 27/08; B32B 27/20; B32B 27/306; B32B 2255/10; B32B 2255/20; B32B 2255/28; B32B 2307/31; B32B 2307/518; B32B 2307/7244; B32B 2307/7246; B32B 2439/00

(57) ABSTRACT

A recyclable flexible laminate for use in a packaging structure, and method of manufacture, comprising a first structure having an inner surface and an outer surface. The first structure comprises machine-direction oriented polyethylene or biaxially oriented polyethylene. The laminate also comprises a second structure having an inner surface and an outer surface, wherein the second structure is machine-direction oriented polyethylene or biaxially oriented polyethylene. The first structure and the second structure are adhesively laminated together using an adhesive.

### CROSS-REFERENCE TO RELATED APPLICATIONS

This application claims benefit of provisional U.S. Application No. 63/299,224, entitled “RECYCLABLE RESEALABLE LAMINATE STRUCTURE,” filed Jan. 13, 2022, which is incorporated herein in its entirety.

### FIELD OF THE INVENTION

The present disclosure relates in general to packaging for products, and more particularly to packaging constructed from recyclable flexible film-based laminate materials. The invention also comprises methods for manufacturing the recyclable laminate packaging structures.

### BACKGROUND

A variety of food and non-food products are packaged using flexible packaging materials formed primarily of laminations of one or more of polymer films, metallized polymer films, paper, metal foil, and the like. In many instances, packages contain products that may be used or consumed a little at a time, and the products may be susceptible to being adversely affected (e.g., becoming soggy, drying out, etc.) by exposure to the surrounding environment. Accordingly, there is a desire to be able to reclose a package after its initial opening to keep product that remains in the package fresh.

Many flexible packaging materials are formed using more than one polymer, (e.g., polyethylene terephthalate (PET) and polypropylene (PP), or PET and polyethylene (PE), or other combinations). The combination of materials provides improved films and packages, as each material can provide a different desirable property. For example, PET may provide flexibility and PE may provide a sealable material and a moisture barrier; thereby a combination laminate comprising PET and PE allows for an extended shelf life and functionality of the products. However, due to the multiple types of polymer used in the laminate, these films are not easily curbside recyclable. Thus, there exists a need for a laminate film which is curbside recyclable and still provides the functional properties expected from current food packages. Through ingenuity and hard work, the present inventor has developed a curbside recyclable resealable laminate which has the desirable functional properties necessary for food packaging.

### SUMMARY

In an embodiment, the invention comprises a laminate for use in flexible packing structures, which is curbside recyclable. The present invention comprises a first structure comprising an oriented polyethylene and a second structure comprising an oriented polyethylene adhesively laminated together. The oriented polyethylene may be machine direction oriented or biaxially oriented.

In an embodiment, the recyclable laminate is formed into a flexible packaging structure. The first structure may be an outer structure, and the second structure may be an inner structure, with reference to a container to which the laminate may be affixed. The laminate has an opening end and a base end and a longitudinal direction which runs between the opening end and the base end. The laminate has at least one outer line of weakness formed in the outer structure, the at least one outer line of weakness defining part of an outer opening portion that is separable from the outer structure along the at least one outer line of weakness, wherein the at least one outer line of weakness terminates in at least one tear receiving element adjacent the opening end of the laminate. The laminate has a first inner line of weakness formed in the inner structure, the first inner line of weakness defining an inner opening portion that is separable from the inner structure along the first inner line of weakness, wherein the inner opening portion is joined to the outer opening portion such that lifting the outer opening portion out of the plane of the flexible packaging structure causes the inner opening portion to be lifted along with the outer opening portion so as to create an opening through the flexible packaging structure and a marginal region of the outer opening portion is defined between the inner and outer lines of weakness, the marginal region overlying an underlying surface of the inner structure. The laminate also comprises a tab defined by at least one line of weakness formed through both the outer structure and the inner structure, wherein the at least one outer line of weakness terminates in at least one tear propagating element and a second inner line of weakness formed in the inner structure, wherein the second inner line of weakness is disposed between the at least one tear propagating element of the tab and the at least one tear receiving element of the at least one outer line of weakness.

### BRIEF DESCRIPTION OF THE SEVERAL VIEWS OF THE DRAWINGS

Having thus described the disclosure in general terms, reference will now be made to the accompanying drawings, which are not necessarily drawn to scale, and wherein:

FIG. 1 illustrates a cross-section of a laminate, in accordance with some embodiments discussed herein;

FIG. 2 illustrates an example orientation process, in accordance with some embodiments discussed herein;

FIGS. 3A-3E illustrate cross-sections of example laminates, in accordance with some embodiments discussed herein;

FIG. 4 illustrates an example cross-section of an example lidding, in accordance with some embodiments discussed herein;

FIG. 5A illustrates a perspective view of a flexible package made from the example laminate, in a closed configuration, in accordance with some embodiments discussed herein;

FIG. 5B illustrates a perspective view of the example flexible package of FIG. 5A in an open configuration, in accordance with some embodiments discussed herein;

FIG. 6 illustrates a perspective view of an example flexible package made from the example laminate in a closed configuration, in accordance with some embodiments discussed herein;

FIG. 7A illustrates a perspective view of an example container with a lidding member made from the example laminate, in a closed configuration, in accordance with some embodiments discussed herein; and

FIG. 7B illustrates the example container of FIG. 6A, in an open configuration, in accordance with some embodiments discussed herein.

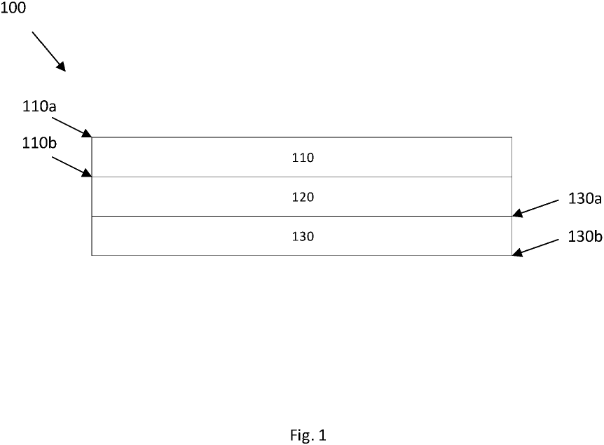

### DETAILED DESCRIPTION

The present inventions now will be described more fully hereinafter with reference to the accompanying drawings, in which some but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

In an embodiment of the invention, a flexible packaging laminate is constructed to have an integral opening and reclose function, a pull tab, and a tamper-evidence feature. The laminate is constructed as a multi-layer structure by adhesively laminating a first structure to a second structure, wherein each of the first and second structures may comprise one or more layers of flexible material. Pressure sensitive adhesive is applied to one of the structures before lamination. Once the laminate is formed in this manner, scoring operations are performed.

In an embodiment, one or more scoring operations are performed on each side of the laminate. In an embodiment, some scoring operations penetrate only through a part of the thickness of the laminate; in particular, a scoring operation performed on the side of the laminate adjacent the first structure results in penetration through the first structure, but without complete penetration through the second structure, and preferably without any substantial penetration, and more preferably without any penetration, into the second structure. Likewise, a scoring operation performed on the side of the laminate adjacent the second structure results in penetration through the second structure, but without complete penetration through the first structure, and preferably without any substantial penetration, and more preferably without any penetration, into the first structure. However, in some scoring operations set forth herein, the scoring comprises a complete penetration through both the first and second structure. The scoring operations may form the peelable/reclosable flap, the pull tab, and the tamper-evidence features, as further described below.

In some embodiments, the package is formed to have an integral opening and reclose feature by forming the laminate as a two-part structure, having an outer structure joined in face-to-face relation with an inner structure. Each of the outer and inner structures can comprise one or more layers of flexible packaging material.

Turning to the figures, the recyclable laminate may be formed from bonded structures of oriented polyethylene. In some embodiments, the polyethylene may be medium density polyethylene (MDPE), or high-density polyethylene (HDPE). In some embodiments, the structures may be machine-direction oriented (“MDO”) or biaxially oriented (“BO”). Oriented polyethylene, in general, provides a heat-resistant, non-extensible film. These characteristics are important for various aspects of the manufacturing process, such as printing and die cutting or perforating.

As discussed in WO 2018/109112, which is herein incorporated in its entirety, the properties of polyethylene films can be modified and, in some instances, improved upon stretching. The stretching is often carried out in the machine direction and known as “mono directional oriented” or machine-direction oriented (MDO) films. MDO films are known to have improved stiffness and impact behaviors.

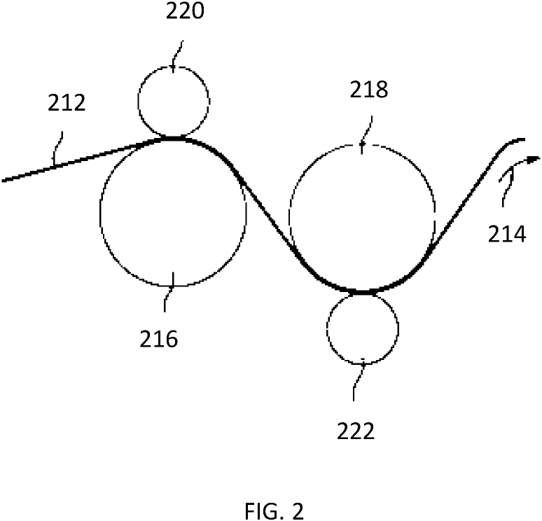

In some embodiments, one of the first or second structures may be a machine direction-oriented film. As discussed in US 2020/0254737, which is herein incorporated in its entirety, a MDO film may begin as a precursor substrate film produced by either a cast film process or a blown film process. The precursor substrate film thus produced may then be stretched via machine direction (MD) orientation by a process analogous to that shown in simplified schematic form in FIG. 2 in order to form a machine direction oriented polymeric film in accordance with the present disclosure. For example, the film 212 shown in FIG. 2 may be passed between at least two pairs of rollers in the direction of an arrow 214. In this example, first roller 216 and a first nip 220 run at a slower speed (V1) than the speed (V2) of a second roller 218 and a second nip 222. The ratio of V2, V1 determines the degree to which the film 214 is stretched. Since there may be enough drag on the roll surface to prevent slippage, the process may alternatively be run with the nips open. Thus, in the process shown in FIG. 2, the first nip 220 and the second nip 222 are optional.

In some embodiments, one of the first or second structures may be biaxially oriented. Biaxial orientation is commonly understood as reheating an existing primary film in a second step with contemporaneous or sequential orientation in both the transverse direction (TD) and the machine direction (MD). Biaxial orientation can be carried out in different ways, namely via double-bubble or flat film (cast film). In some embodiments, the first and second structures may be either machine-direction oriented (MDO) or biaxially oriented (BO) polyethylene (PE).

For example, in a first embodiment, the first structure may be machine-direction oriented (MDO) polyethylene and the second structure may be biaxially oriented (BO) polyethylene. In a second embodiment, the second structure may be machine-direction oriented (MDO) polyethylene and the first structure may be biaxially oriented (BO) polyethylene. In a third embodiment, the first and second structures may be machine-direction oriented (MDO) polyethylene. In a fourth embodiment, the first and second structures may be biaxially oriented (BO) polyethylene.

In an embodiment, either or both structures may be crosslinked. Any crosslinking methods can be utilized to crosslink the structures layers, which may include, but is not limited to chemical, physical, or mechanical crosslinking. Crosslinking may decrease the extensibility of the laminate, improve barrier properties of the laminate, and/or increase heat resistance of the laminate. In an embodiment, electron beam crosslinking methodologies may be applied to crosslink the first and/or second structure.

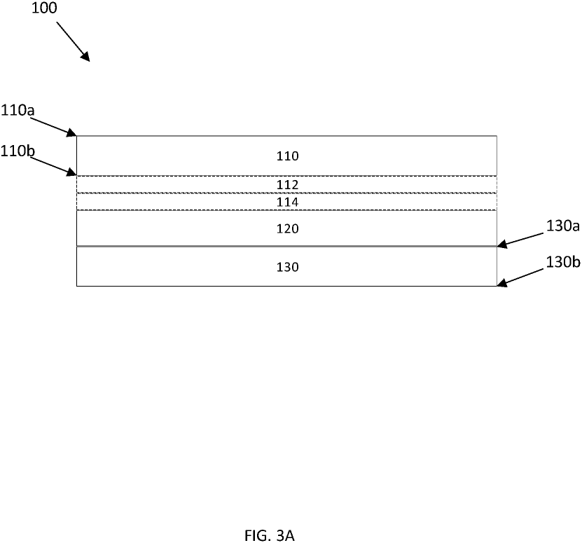

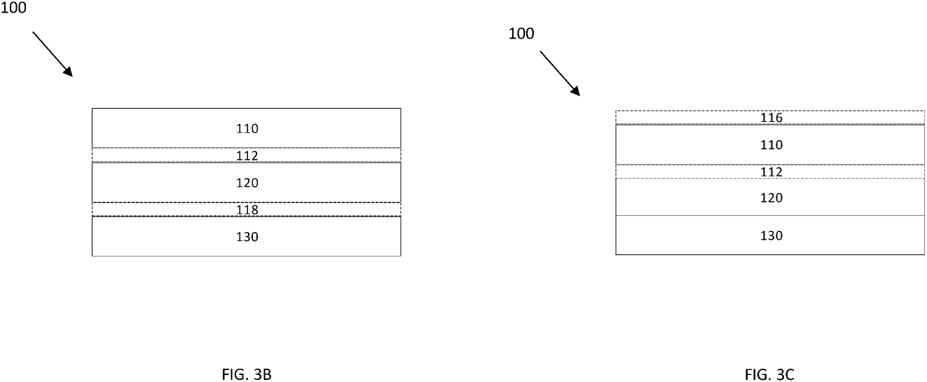

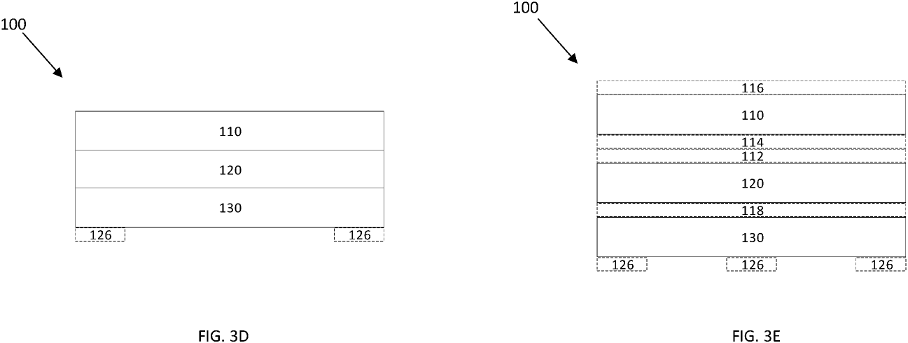

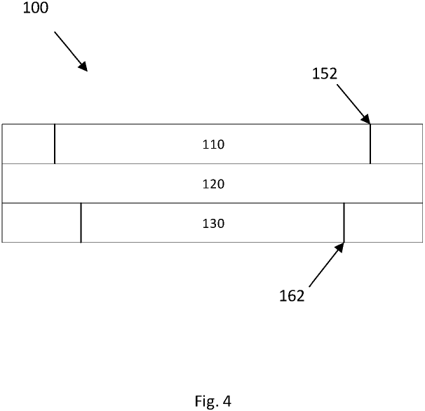

Turning to FIGS. 3A-3E, in the method of manufacture of the laminate 100, a first structure 110 (optionally the outer structure with respect to the interior space of a packing structure) defining an outer surface 110a and an inner surface 110b may be advanced from a supply roll. One or both surfaces of the first structure 110 may be optionally treated by corona discharge or a flame treatment to render the surface(s) more receptive to inks, surface printing, heat seal coatings, and/or heat-resistant overlacquers, and/or to render the surface(s) more readily bondable to the adhesive 120 (pressure sensitive and/or permanent) that is subsequently applied to the surface as described below. The first structure 110 may optionally be pre-printed or may be printed as a part of the presently described manufacturing process. Optionally ink 112 and primer 114 layers may be applied to the outer surface 110a of the first structure or to the inner surface 110b (see FIG. 3A) via a reverse printing process. The first structure may comprise one or more layers of oriented polyethylene.

In an embodiment, a second structure 130 defining an outer surface 130a and an inner surface 130b may also be advanced from a supply roll. The second structure may have the same orientation as the first structure 110, or in some embodiments, may have a different orientation. One or both of the outer and inner surfaces of the second structure 130 may be optionally treated by corona discharge or a flame treatment, as set forth above, or may be printed, reverse-printed, or the like. The second structure may be coextensive with the first structure 110 (i.e., the width of the second structure may be substantially equal to the width of the first structure and the longitudinal edges of the second structure may substantially coincide with the longitudinal edges of the first structure). As used herein, the longitudinal edges of the first structure, second structure, and/or laminate refer to the edges which extend in the machine direction of the film, perpendicular to the edge of the film wherein the roll is initiated. In an embodiment, the second structure 130 comprises the inner film structure and the first structure 110 comprises the outer film structure, with respect to the resulting laminate. The second structure 130 may comprise one or more layers of oriented polyethylene.

In some embodiments, the first structure 110 and the second structure 130 may be formed from the same film. In some embodiments, the structures may be made from machine direction-oriented polyethylene. A laminate from MDO-PE may exhibit a high strength in the machine direction.

In some embodiments, both the first structure and the second structure may be formed from a BOPE. A laminate made from BOPE may exhibit a greater strength in both the machine direction and the transverse direction.

In some embodiments, the structures of the laminate may have different orientations. For example, the first structure may be made from an MDO-PE and the second structure may be made from a BOPE. In other embodiments, the first structure may be made from a BOPE, and the second structure may be made of MDO-PE.

In some embodiments, each structure may be stretched to a thickness of under 3 mils, or in another embodiment to a thickness of under 2 mils, or in another embodiment to a thickness of under 1.5 mils, or in still another embodiment to a thickness of under 1.25 mils. In a particular embodiment, the thickness of the oriented PE is between about 0.7 mils and 1.6 mils, or in another embodiment to a thickness between about 0.75 mils and 1.5 mils. In an exemplary embodiment the thickness of each structure is between about 0.8 mils and 1.4 mils, or in another embodiment between about 0.9 mils and 1.25 mils. In some embodiments, the second structure 130 may have a greater thickness than the first structure 110, while in other embodiments, the first structure 110 and the second structure 130 may have equal or substantially equal thicknesses. In some embodiments, the thickness of each the first structure 110 and the second structure 130 may correspond to the package, for example a stand-up package may utilize a laminate thicker than the laminate used in a flow wrap package.

In an embodiment, an adhesive layer 120 is applied to the first structure (inner surface) and/or the second structure (outer surface). In an embodiment, the adhesive 120 is a pressure sensitive adhesive. In an embodiment, the pressure sensitive adhesive is flood coated (100% coverage) onto the surface of the relevant structure. In an embodiment, the pressure sensitive adhesive may cover substantially the entirety or the entirety of the first structure and/or second structure. In other embodiments, the pressure sensitive adhesive is pattern-applied. In some embodiments, the adhesive layer 120 may be cured before or during application to enhance the release properties.

The pressure sensitive adhesive can comprise various compositions. Pressure sensitive adhesives form viscoelastic bonds that are aggressively and permanently tacky, adhere without the need of more than a finger or hand pressure, and require no activation by water, solvent or heat. Pressure sensitive adhesives are often based on non-crosslinked rubber adhesives in a latex emulsion or solvent-borne form, or can comprise acrylic and methacrylate adhesives, styrene copolymers (SIS/SBS), and silicones. Acrylic adhesives are known for excellent environmental resistance and fast-setting time when compared with other resin systems. Acrylic pressure sensitive adhesives often use an acrylate system. Natural rubber, synthetic rubber or elastomer sealants and adhesives can be based on a variety of systems such as silicone, polyurethane, chloroprene, butyl, polybutadiene, isoprene, or neoprene. When the packaging laminate of the invention is to be used for food packaging, the pressure sensitive adhesive generally must be a food grade composition. Various pressure sensitive adhesives are approved by the U.S. Food and Drug Administration for use in direct food contact, as regulated by 21 CFR Part 175.300. A food-grade pressure sensitive adhesive for use in the present invention is Jonbond 743 available from Bostik Findley. The adhesive application can comprise any suitable device capable of applying the pressure sensitive adhesive to the structure and the pressure sensitive adhesive may comprise any pressure sensitive adhesive known in the art. After application of the pressure sensitive adhesive, the relevant structure may be advanced to a dryer such as an oven or the like, to dry or partially dry the pressure sensitive adhesive.

Optionally, a permanent laminating adhesive may be pattern applied to the first or second structure in one or more locations within the adhesive layer 120. The permanent adhesive can comprise various compositions. Suitable examples include two-component polyurethane adhesive systems, such as Tycel 7900/7283 available from Henkel.

The first and second structures may be laminated together, such as via a pair of rolls forming a nip therebetween. The first and second structures may be passed through the nip and laminated to each other. In a typical process, the laminate 100 would then be advance to a reel-up where it is wound into a roll for subsequent processing in a second, offline scoring phase of the manufacturing process, and a third, off line application phase of the manufacturing process. In the present invention, however, the scoring steps of the invention may be performed in-line with the lamination steps. In the process of the invention, the manufacture of the laminate and the incorporation of the opening/reclose features in the laminate are conducted in an in-line fashion as part of the same overall process. The process of the invention thus is much more efficient and less costly.

In some embodiments, the laminate may have a durometer value and a tensile strength sufficient to be die cut. In some embodiments, the die cut may be a continuous line, and in other embodiments the die cut may consist of perforations through the laminate 100. In some embodiments, each of the first and second structures of the laminate may have a durometer value and a tensile strength to withstand a die cut and/or perforation without reaching the other structure.

In some embodiments, the laminate may include additional layers to provide desired properties while maintaining the recyclability of the laminate. For example, the laminate may be configured to provide barrier properties, including moisture, water, carbon dioxide, and/or oxygen barriers. In some embodiments, the laminate may include a metalized layer 118. In some embodiments, the oriented PE may be metalized 118 to provide improved barrier properties. Since the metalized layer will be de minimis, the laminate will be readily recyclable. In some embodiments, the metallization may be on one side of either the first structure 110 or the second structure 130, while in other embodiments, both the first structure 110 and the second structure 130 may be metalized. In some embodiments, a metal layer 118 may be disposed adjacent the outer surface of the inner structure 130 (see FIG. 3B).

In some embodiments, the laminate may have a moisture barrier 116 disposed on an outer surface of first structure 110. The moisture barrier 116 may be used to improve the barrier properties of the laminate 100.

In some embodiments, the first structure or second structure may include a barrier layer providing a barrier against the passage of moisture and/or oxygen. In some applications such as the packaging of moisture-sensitive products (e.g., cookies or similar products that tend to be degraded when exposed to the environment), it is important to provide a moisture barrier. The barrier layer can comprise any of various polymer-based barrier materials including barrier polymer films such as ethylene vinyl alcohol copolymer (EVOH), polyamide, and the like; metallized polyolefin films such as polyethylene, polypropylene, oriented polypropylene, and the like; aluminum oxide- (AlOx)-coated polymer films; silicon oxide- (SiOx)-coated polymer films; metal foil such as aluminum foil; and others. Although the term “barrier layer” is used in connection with metallized films to refer to the entire metallized film, it will be recognized that it is the layer of metal that provides the barrier function. Likewise, it is the AlOx or SiOx coating that provides the barrier function in the ceramic-coated films, but the entire film nevertheless is referred to herein as a “barrier layer”.

In some embodiments, the ink layer 112 may be reverse printed on to the inner surface of the first structure 110. In some embodiments, a primer 114 may be printed onto the inner surface of the first structure 110 to improve the adhesion between the ink layer 112 and the first structure 110. In other embodiments the ink layer 112 may be surface printed on the exterior side of the first surface 110. In some embodiments, the ink may be applied before the barrier layer, and in other embodiments, the ink may be applied to the barrier layer.

In some embodiments, an overlacquer may be applied to the laminate 100. An overlacquer may be applied to an outer surface of the first structure 110, optionally as the outermost layer, or may be applied to the inner surface of the first structure 110. In some embodiments, the overlacquer may be applied adjacent to the adhesive layer 120. In some embodiments, the overlacquer may be heat resistant.

In some embodiments, the laminate 100 may be heat sealable. In some embodiments, the second structure 130 may be inherently heat sealable. In some embodiments, the second structure may be a “skin” layer. For example, the second structure 130 may be coextruded with a heat seal coating on its innermost side, such that the inner surface is heat sealable. In other embodiments, a heat seal coating 126 may be applied, optionally pattern-applied, to the inner surface of the second structure, as illustrated in FIGS. 3D-3E. In some embodiments, the pattern applied heat seal may be used in application to a thermoformed tub, or application to another recyclable container. The second structure 130 may additionally be free from slip.

Additionally, in some embodiments, a friction coating (also known as a coefficient of friction (COF) coating) may be applied to the inner surface of the second structure 130. The friction coating may be applied in conjunction with the heat seal skin or a pattern applied heat seal coating. In some embodiments, the friction coating may reduce the friction between layers of the laminate when rolled into supply rolls or subsequently formed into packaging.

In some embodiments, a colorant may be added to one or more of the structures. For example, a white colorant may be added to the second structure 130 to improve optics of the laminate, while not altering the properties of the laminate 100.

In some embodiments, the first structure 110 and second structure 130 may account for up to 90% of the weight of the laminate 100, up to 95% of the weight of the laminate 100, or even up to 99% of the weight of the laminate 100.

In some embodiments, polyethylene may account for up to 90% of the weight of the laminate 100, up to 95% of the weight of the laminate 100, or even up to 99% of the weight of the laminate 100.

As illustrated in FIG. 3E each of the layers as discussed herein may be used individually, or in combination with one another to improve the properties of the laminate, while maintaining recyclability.

Manufacturing equipment may be provided which can apply adhesive, laminate layers, and score the laminate within the same processing line. In an embodiment, the scoring equipment comprises a laser scoring device. The depth of the score line formed by a laser can be regulated by regulating the power output or beam intensity of the laser beam, the width or spot size of the laser beam, and the amount of time a given spot on the film surface is irradiated by the beam. These factors generally are selected based on the characteristics of the material being scored. Some materials are more readily scored by lasers than other materials, as known in the art. The depth of the score line formed by the laser can be regulated by regulating the power output or beam intensity of the laser beam, the width or spot size of the laser beam, and the amount of time a given spot on the film surface is irradiated by the beam. These factors generally are selected based on the characteristics of the material being scored. In some embodiments, a laser with a wavelength between 10 and 11 microns may be used to score oriented polyethylene. In an example embodiment, a laser with a wavelength of 10.2 microns may be used to score the laminate structure 100. In other embodiments, a wavelength of 10.6 microns may be utilized.

As illustrated in FIG. 4 the laminate structure 100 may include lines of weakness or score lines. The orientation of the films creates a structure capable of being scored, laser cut, die cut perforated, or any other method known in the art to create the lines of weakness. In some embodiments, the laminate may contain a line of weakness 152 in the first structure 110, and a second line of weakness 162 in the second structure 130.

The laminate 100, may be used to form a flexible packing structure, as described within U.S. Application Serial No. 17/031,154, which is herein incorporated in its entirety. The laminate 100, may be used as a lidding member for a thermoformed tub, as described within U.S. Application Serial No. 17/508,075, which is herein incorporated in its entirety. As described above the first structure 110 may also be referred to as an outer structure, and the second structure 130 may be referred to as an inner structure.

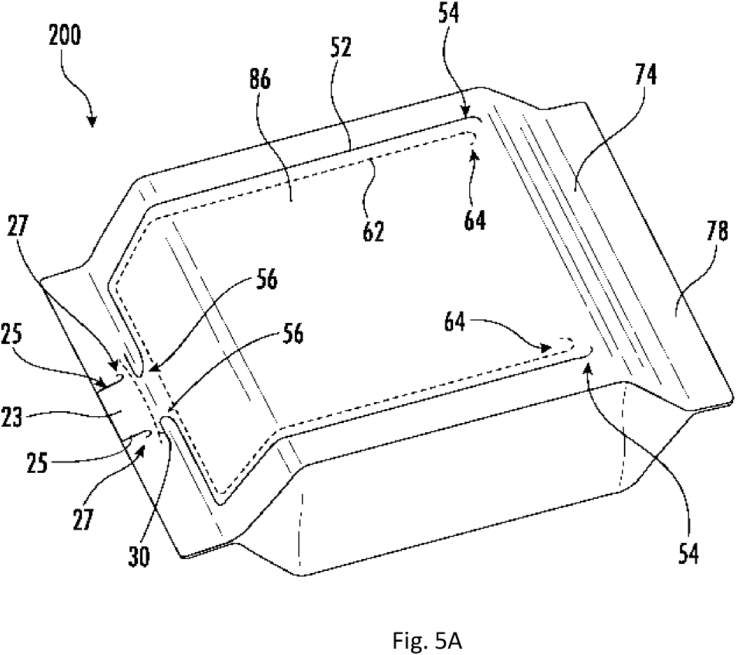

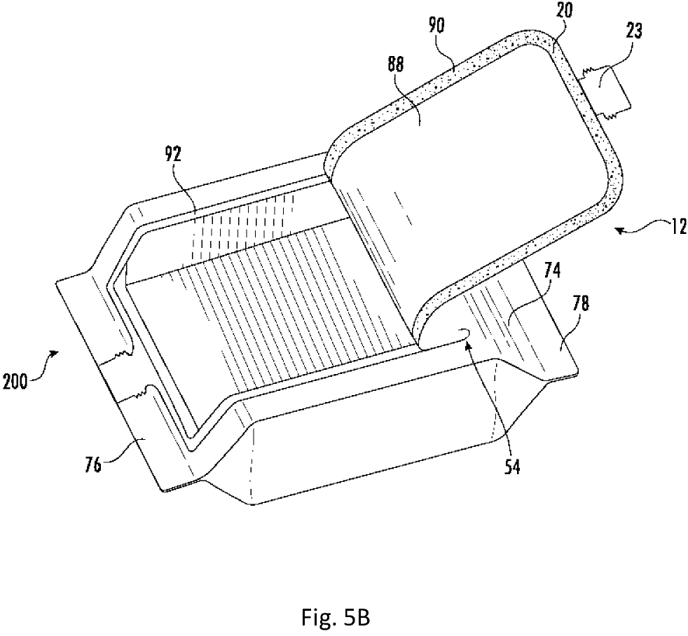

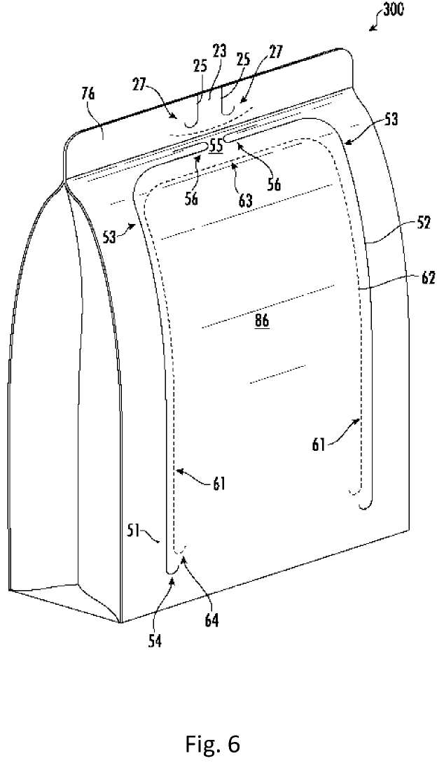

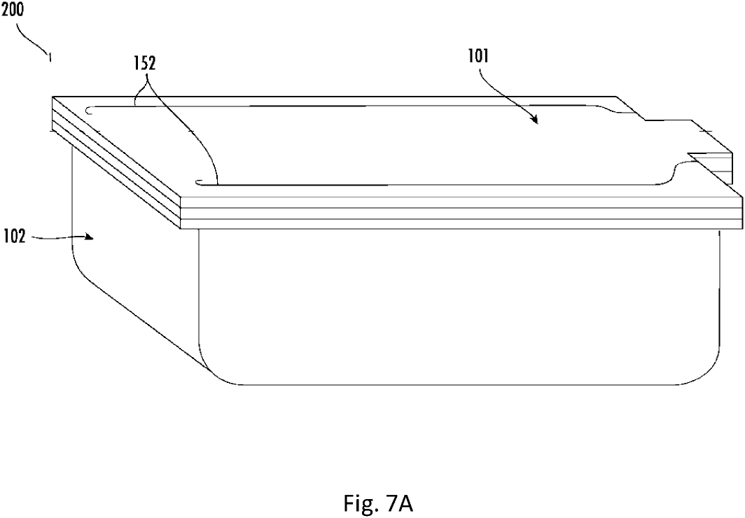

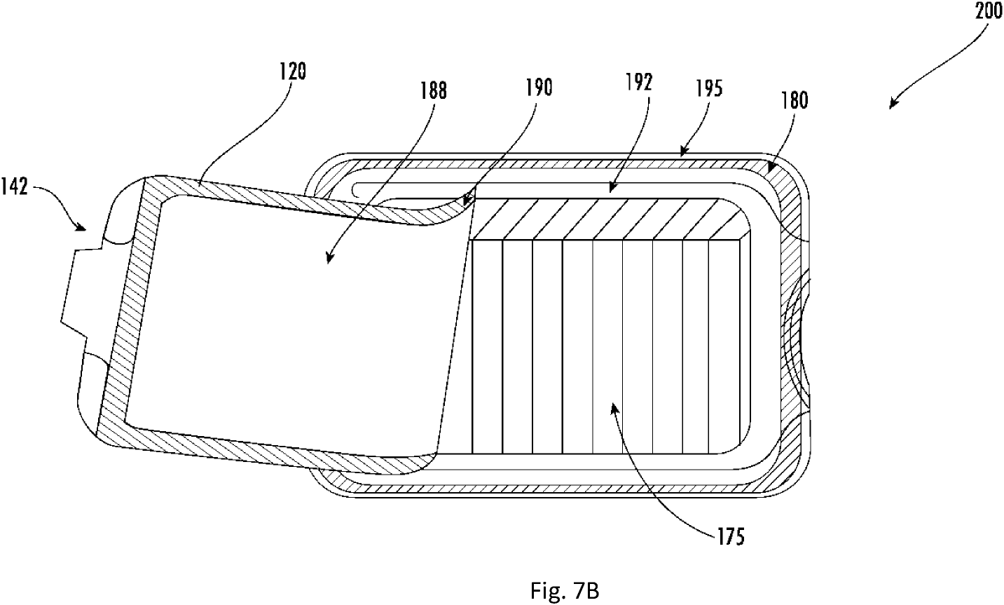

FIGS. 5A-5B illustrate an example flexible packaging structure 200 made from the laminate 100 in a closed and open configuration respectively. Similarly, FIG. 6 illustrates an example flexible packaging structure 300 made from the laminate 100 configured as a standup pouch. FIGS. 7A-7B illustrate the laminate 100 configured as a flexible lidding member 101 adhered to a container 102 in a closed and an open configuration.

In both the packaging structure, and the lidding member an outer line of weakness is formed in the outer structure to define an outer opening portion that can be lifted out of the plane of the outer structure. Similarly, an inner line of weakness is formed in the inner structure to define an inner opening portion that can be lifted out of the plane of the inner structure. The outer and inner opening portions are attached to each other such that the outer and inner opening portions can be lifted out of the plane as a unit, thereby creating an opening through the packaging structure defined by the inner line of weakness.

The outer opening portion is larger in area than the inner opening portion and has a marginal region that extends beyond the peripheral edge of the inner opening portion. When the outer and inner opening portions are lifted out of the plane to create the opening, an underlying portion of the inner structure in registration with the marginal region of the outer opening portion is exposed adjacent the opening. A pressure sensitive adhesive is applied to the inner surface of the outer structure and/or the outer surface of the inner structure. In an embodiment, the pressure sensitive adhesive is flood coated (100% coverage) over the inner surface of the outer structure and/or the outer surface of the inner structure. Therefore, after initial lifting of the outer and inner opening portions, the opening through the structure can be reclosed by adhering the marginal region of the outer opening portion to the underlying portion of the inner structure via the pressure sensitive adhesive.

In an embodiment, the outer structure is adhesively joined to the inner structure via a pressure sensitive adhesive so as to form a laminate. The adhesive can be applied using any suitable equipment and techniques known in the art. In an embodiment, the pressure sensitive adhesive need not be applied such that there is a region that is free of the adhesive or is deadened to such adhesive, such as in the region of the pull tab. An adhesive-free region or deadened region between the inner and outer structure is not necessary in the present invention because the pull tab, in an embodiment, comprises both the inner and outer structure. In contrast to existing packaging structures, the tab of the present invention is not comprised of just the outer structure. The outer structure and inner structure may be coextensive with each other and may each be continuous webs drawn from respective supply rolls and laminated together to form a laminate that is a continuous web.

In an embodiment, the laminate may be thereafter scored to form one or more outer lines of weakness (also referred to herein as “score lines”) through the thickness of the outer structure, one or more inner score lines through the thickness of the inner structure, and one or more throughout score lines which extend through the outer structure and the inner structure. Advantageously, because the structure is flood coated with pressure sensitive adhesive, the score lines need not be registered with respect to the adhesive or, in an embodiment, any printed material.

In an embodiment, the outer score line delineates the outer opening portion of the outer structure that is separable from the remainder of the outer structure along the outer score line, and the inner score line delineates the inner opening portion of the inner structure that is affixed to the outer opening portion by the adhesive and is separable from the remainder of the inner structure along the inner score line. The outer line of weakness or score line preferably penetrates through the thickness of the outer structure but not through the inner structure. Similarly, the inner score line preferably penetrates through the thickness of the inner structure but not through the outer structure.

In an embodiment, a separate inner score line defines a portion of the tamper evidence feature. In an embodiment, a throughout score line penetrates through the thickness of the inner and outer structure and defines at least a portion of the pull tab. In an embodiment, the score lines are formed by laser scoring. However, other methods, such as mechanical scoring, die cutting, kiss cutting, or a combination thereof may be utilized. The inner structure or outer structure may include a barrier layer providing a barrier against the passage of moisture and/or oxygen. In some applications such as the packaging of moisture-sensitive products (e.g., cookies or similar products that tend to be degraded when exposed to the environment) or oxygen-sensitive products, a moisture barrier and/or oxygen barrier may be included. The barrier layer can comprise any barrier known in the art, such as metallization, AlOx coatings, SiOx coatings, metal foil, aluminum foil, and others. Although the term “barrier layer” is used in connection with metallized films to refer to the entire metallized film, it will be recognized that it is the layer of metal that provides the barrier function. Likewise, it is the AlOx or SiOx coating that provides the barrier function in the ceramic-coated films, but the entire film nevertheless is referred to herein as a “barrier layer”.

In an embodiment, the outer structure may comprise reverse-printed ink, primer, and acrylic layers. In an embodiment, the inner structure is heat sealable. In an embodiment, the inner structure may be metalized or may include and aluminum oxide barrier.

Turning to particulars, in the method of manufacture, a first structure (optionally the outer structure) may be advanced from a supply roll. One or both surfaces of the first structure may be optionally treated by corona discharge or a flame treatment to render the surface(s) more receptive to inks and/or to render the surface(s) more readily bondable to the pressure sensitive adhesive that is subsequently applied to the surface as described below. The first structure may optionally be pre-printed or may be printed as a part of the presently described manufacturing process. The inks and printing may be applied to the exterior surface of the first structure or to the interior surface via a reverse printing process. The first structure may comprise one or more layers of flexible packaging material, including polymers such polyesters, polyolefins (including homopolymers and copolymers), polyamides, and others, paper, and/or metal foil.

In an embodiment, a second structure may also be advanced from a supply roll. One or both surfaces of the second structure may be optionally treated by corona discharge or a flame treatment, as set forth above, or may be printed, reverse-printed, or the like. The second structure may be coextensive with the first structure (i.e., the width of the second structure may be substantially equal to the width of the first structure and the longitudinal edges of the second structure may substantially coincide with the longitudinal edges of the first structure). As used herein, the longitudinal edges of the first structure, second structure, and/or laminate refer to the edges which extend in the machine direction of the film, perpendicular to the edge of the film wherein the roll is initiated. In an embodiment, the second structure comprises the inner film structure and the first structure comprises the outer film structure, with respect to the resulting laminate.

In an embodiment, a pressure sensitive adhesive is applied to the first structure and/or the second structure. In an embodiment, the pressure sensitive adhesive is flood coated (100% coverage) onto the surface of the relevant structure. In an embodiment, the pressure sensitive adhesive may cover substantially the entirety of the first structure and/or second structure. The pressure sensitive adhesive can comprise various compositions. Pressure sensitive adhesives form viscoelastic bonds that are aggressively and permanently tacky, adhere without the need of more than a finger or hand pressure, and require no activation by water, solvent or heat. Pressure sensitive adhesives are often based on non-crosslinked rubber adhesives in a latex emulsion or solvent-borne form, or can comprise acrylic and methacrylate adhesives, styrene copolymers (SIS/SBS), and silicones. Acrylic adhesives are known for excellent environmental resistance and fast-setting time when compared with other resin systems. Acrylic pressure sensitive adhesives often use an acrylate system. Natural rubber, synthetic rubber or elastomer sealants and adhesives can be based on a variety of systems such as silicone, polyurethane, chloroprene, butyl, polybutadiene, isoprene, or neoprene. When the packaging laminate of the invention is to be used for food packaging, the pressure sensitive adhesive generally must be a food grade composition. Various pressure sensitive adhesives are approved by the U.S. Food and Drug Administration for use in direct food contact, as regulated by 21 CFR Part 175.300. A food-grade pressure sensitive adhesive for use in the present invention is Jonbond 743 available from Bostik Findley. The adhesive application can comprise any suitable device capable of applying the pressure sensitive adhesive to the structure and the pressure sensitive adhesive may comprise any pressure sensitive adhesive known in the art. After application of the pressure sensitive adhesive, the relevant structure may be advanced to a dryer such as an oven or the like, to dry or partially dry the pressure sensitive adhesive.

Optionally, a permanent laminating adhesive may be pattern applied to the first or second structure in one or more locations. The permanent adhesive can comprise various compositions. Suitable examples include two-component polyurethane adhesive systems, such as Tycel 7900/7283 available from Henkel.

The first and second structures may then be laminated together, such as via a pair of rolls forming a nip therebetween. The first and second structures may be passed through the nip and laminated to each other. In a typical process, the laminate would then be advance to a reel-up where it is wound into a roll for subsequent processing in a second, offline scoring phase of the manufacturing process. In the present invention, however, the scoring steps of the invention may be performed inline with the lamination steps. In the process of the invention, the manufacture of the laminate and the incorporation of the opening/reclose and tamper-evidence features in the laminate are conducted in an in-line fashion as part of the same overall process. The process of the invention thus is much more efficient and less costly.

Manufacturing equipment may be provided which can apply adhesive, laminate layers, and score the laminate within the same processing line. In an embodiment, the scoring equipment comprises a laser scoring device. The depth of the score line formed by a laser can be regulated by regulating the power output or beam intensity of the laser beam, the width or spot size of the laser beam, and the amount of time a given spot on the film surface is irradiated by the beam. These factors generally are selected based on the characteristics of the material being scored. Some materials are more readily scored by lasers than other materials, as known in the art. The depth of the score line formed by the laser can be regulated by regulating the power output or beam intensity of the laser beam, the width or spot size of the laser beam, and the amount of time a given spot on the film surface is irradiated by the beam. These factors generally are selected based on the characteristics of the material being scored.

In an embodiment, several score lines may be formed in the laminate as part of the scoring process. The several score lines may be formed simultaneously or may be formed sequentially, in any sequence known in the art. Thus, while the steps herein are referred to as first, second, etc., the process should not be so limited.

The packages described above are formed by completely enveloping the contents in the flexible laminate. Alternatively, however, it is within the scope of the invention to employ the flexible laminate as a lidding stock for forming flexible lids that can be secured (e.g., by heat-sealing or the like) to a flange of a tray or other container that contains the contents. In this manner, the lid includes a built-in opening and reclose feature as previously described.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A recyclable laminate comprising:
a first structure having an inner surface and an outer surface, wherein the first structure comprises machine-direction oriented polyethylene or biaxially oriented polyethylene; and
a second structure having an inner surface and an outer surface, wherein the outer surface of the second structure is adhesively bonded to the inner surface of the first structure, and wherein the second structure is machine-direction oriented polyethylene or biaxially oriented polyethylene.

2. The recyclable laminate of claim 1, wherein the adhesive bond comprises a permanent adhesive and a pattern-applied pressure sensitive adhesive.

3. The recyclable laminate of claim 1, wherein the adhesive bond comprises solely pressure sensitive adhesive.

4. The recyclable laminate of claim 1, further comprising an ink layer disposed on the outer surface or the inner surface of the first structure or the outer surface of the second structure.

5. The recyclable laminate of claim 1, wherein the inner surface of the first structure or the outer surface of the second structure is metalized.

6. The recyclable laminate of claim 1, wherein one of the outer surface or the inner surface of the first structure, or the outer surface or the inner surface of the second structure further comprises a moisture barrier, an oxygen barrier, or both.

7. The recyclable laminate of claim 1, wherein the first structure and the second structure each comprise machine-direction oriented polyethylene.

8. The recyclable laminate of claim 1, wherein the first structure and the second structure each comprise biaxially-oriented polyethylene.

9. The recyclable laminate of claim 1, wherein the first structure is machine direction-oriented polyethylene and the second structure is biaxially oriented polyethylene.

10. The recyclable laminate of claim 1, wherein the first structure is biaxially oriented polyethylene and the second structure is machine direction-oriented polyethylene.

11. The recyclable laminate of claim 1, further comprising a pattern-applied heat seal coating disposed on the inner surface of the second structure.

12. The recyclable laminate of claim 1, further comprising an over lacquer disposed on the outer surface of the first structure.

13. The recyclable laminate of claim 1, further comprising a heat sealable skin layer disposed on the inner surface of the second structure.

14. The recyclable laminate of claim 1, wherein the second structure further comprises a white coloring additive.

15. The recyclable laminate of claim 1, wherein the durometer value of the laminate is sufficient for die cutting, perforating, or laser cutting the laminate.

16. The recyclable laminate of claim 1, wherein the tensile strength of the laminate is sufficient for die cutting, perforating, or laser cutting the laminate.

17. The recyclable laminate of claim 1, wherein the first structure and second structure account for at least 95% of the laminate by weight.

18. The recyclable laminate of claim 1, wherein the first structure and the second structure account for at least 98% of the laminate by weight.

19. The recyclable laminate of claim 1, wherein the first structure or the second structure is crosslinked with an electron beam.

20. The recyclable laminate of claim 1, wherein the first structure and the second structure are crosslinked with an electron beam.

21. A stand-up package comprising the recyclable laminate of claim 1.

22. The recyclable laminate of claim 1, wherein the inner surface of the first structure or the outer surface of the second structure comprises a barrier.

23. The recyclable laminate of claim 22, wherein the barrier is ethylene vinyl alcohol copolymer, aluminum oxide or silicon oxide.

24. The recyclable laminate of claim 1, further comprising a pattern-applied cold seal coating or cohesive coating disposed on the inner surface of the second structure.

25. The laminate of claim 1, wherein at least one of the first structure and the second structure is a multilayer polyethylene film.
